(19) United States
(12) Patent Application Publication
(10) Pub. No.: US 2015/0261686 A1
(43) Pub. Date: Sep. 17, 2015

(54) SYSTEMS AND METHODS FOR SUPPORTING DEMAND PAGING FOR SUBSYSTEMS IN A PORTABLE COMPUTING ENVIRONMENT WITH RESTRICTED MEMORY RESOURCES

(71) Applicant: QUALCOMM INCORPORATED, SAN DIEGO, CA (US)

(72) Inventors: SANKARAN NAMPOOTHIRI, BANGALORE (IN); ARUN VALIAPARAMBIL, BANGALORE (IN); SUBODH SINGH, BANGALORE (IN); AZZEDINE TOUZNI, SAN DIEGO, CA (US)

(73) Assignee: QUALCOMM INCORPORATED, SAN DIEGO, CA (US)

(21) Appl. No.: 14/210,512

(22) Filed: Mar. 14, 2014

(51) Int. Cl. G06F 12/10; G06F 9/455; G06F 11/16; G06F 13/28; G06F 13/24

(52) U.S. Cl. CPC G06F 12/1009; G06F 13/28; G06F 13/24; G06F 11/1666; G06F 9/45533; G06F 2212/403; G06F 2009/45575

(57) ABSTRACT

A portable computing device is arranged with one or more subsystems that include a processor and a memory management unit arranged to execute threads under a subsystem level operating system. The processor is in communication with a primary memory. A first area of the primary memory is used for storing time critical code and data. A second area is available for demand pages required by a thread executing in the processor. A secondary memory is accessible to a hypervisor. The processor generates an interrupt when a page fault is detected. The hypervisor, in response to the interrupt, initiates a direct memory transfer of information in the secondary memory to the second area available for demand pages in the primary memory. Upon completion of the transfer, the hypervisor communicates a task complete acknowledgement to the processor.

### DESCRIPTION OF THE RELATED ART

Computing devices are ubiquitous. Some computing devices are portable such as smartphones, tablets and laptop computers. In addition to the primary function of these devices, many include elements that support peripheral functions. For example, a cellular telephone may include the primary function of enabling and supporting cellular telephone calls and the peripheral functions of a still camera, a video camera, global positioning system (GPS) navigation, web browsing, sending and receiving emails, sending and receiving text messages, push-to-talk capabilities, etc. As the functionality of such portable computing devices increases, the computing or processing power required and generally the data storage capacity to support such functionality also increases. However, manufacturers of cellular telephones and other portable computing devices are motivated by power consumption, size, weight and device production costs to identify and implement performance improvements without necessarily increasing the data storage capacity available to the various subsystems implemented in these devices.

Some conventional designs for handheld portable computing devices include multiple processors and/or processors with multiple cores to support the various primary and peripheral functions desired for a particular computing device. Such designs often integrate analog, digital and radio-frequency circuits or functions on a single substrate and are commonly referred to as a system on a chip (SoC). Some of these highly integrated systems or subsystems of the portable computing device include a limited number of internal memory circuits to support the various processors. Some other integrated systems or subsystems of the portable computing device share memory resources available on the portable computing device. Thus, optimizing memory requirements for each supported subsystem is an important factor in ensuring a desired user experience is achieved in an environment with limited random access memory (RAM) capacity.

Demand paging is a known method for reducing memory capacity requirements under such circumstances. Demand paging is a mechanism where delay intolerant code is placed in RAM when the system is initialized and delay tolerant code gets transferred into RAM when it is needed by a process. Thus, pages that include delay tolerant code are only transferred into RAM if the executing process demands them. Contrast this to pure swapping, where all memory for a process is swapped from secondary storage to main memory during the process startup.

Commonly, to achieve this process a page table implementation is used. The page table maps logical memory to physical memory. The page table uses a bitwise operator to mark if a page is valid or invalid. A valid page is one that currently resides in main memory. An invalid page is one that currently resides in the secondary memory and that must be transferred to the main memory.

In some conventional implementations of portable computing devices, such as those supported by multiple processors functioning in separate execution environments, demand paging is supported with controllers enabled with NAND logic circuits. These conventional implementations use multiple channels to manage the data transfers. The introduction of embedded multimedia card (eMMC) based memory, which includes a single port, preempts the use of the conventional controllers using conventional paging methods as many of the controllers cannot support access from multiple processors running in separate execution environments.

### SUMMARY OF THE DISCLOSURE

Example embodiments of systems and methods are disclosed that manage page transfers from a virtual memory space or map to a physical memory. The systems and methods reduce paging overhead demands on subsystems and are applicable on computing devices that include storage systems that support both single and multiple channel memory systems. The systems and methods are scalable and can be exposed to, or used by, multiple subsystems on a portable computing device. A hypervisor operating in a software layer executing at a higher privilege level than a subsystem operating system receives interrupt requests for demand pages from a subsystem processor. The hypervisor includes an interrupt handler that submits jobs to a task scheduler. The task scheduler interacts with appropriate drivers to initiate a transfer of a requested page to the physical memory. Completion of the transfer is communicated to the hypervisor from a device driver. The hypervisor, acting in response to an indication that the transfer is complete, communicates a paging complete acknowledgement to the sub-system processor. Upon receipt of the acknowledgement, the subsystem processor marks the faulting task or thread as ready for execution. The subsystem either resumes execution of the suspended thread or leaves the thread in a queue in accordance with a scheduling policy implemented on the subsystem.

The systems and methods are scalable across multiple subsystems within a portable computing device and introduce negligible subsystem overhead for on demand paging. The systems and methods provide a solution that enables manufacturers to reduce subsystem memory requirements

An example embodiment includes a processor supported by a memory management unit, a first or volatile memory (e.g., a random access memory or RAM), a second or non-volatile memory (e.g., a system memory supported by a flash-based element or elements), and a hypervisor. The processor and the memory management unit are arranged to execute threads in accordance witha subsystem level operating system that identifies a page fault and generates an interrupt when the volatile memory supporting the subsystem does not contain a desired page. The second or non-volatile memory is coupled to an application processor operating under a device level operating system. The first or volatile memory includes a first area for time critical code and read only data and a second area for pages required by a thread executing under the subsystem level operating system on the processor. The second or non-volatile memory is accessible to the hypervisor, which is operating in accordance with execution privileges that supersede respective execution privileges of the main operating system. The hypervisor responds to the interrupt issued by the processor in the subsystem. The hypervisor reads information stored in the second or non-volatile memory, loads the information into the first or volatile memory, and forwards a task complete acknowledgement to the processor.

An example embodiment includes a method for supporting on-demand paging across subsystems in a portable computing environment with limited memory resources. The method includes the steps of: arranging a first physical memory element with a first storage region and a second storage region, storing delay intolerant code in the first storage region and delay tolerant code in the second storage region, arranging a second physical memory element with a respective first area that mirrors the content of the first storage region and a second area, the second physical memory element coupled to the first physical memory element through a hypervisor, detecting a page fault related to a task executing in a subsystem, placing the task in a wait queue, communicating an interrupt to the hypervisor, using the hypervisor to manage a transfer of information identified as missing from the second physical memory element by the page fault from the first physical memory element to the second physical memory element, communicating an interrupt to the subsystem, and changing an indicator associated with the task.

Another example embodiment is a non-transitory processor-readable medium having stored therein processor instructions and data that direct the processor to perform various functions including generating a hypervisor having an interrupt handler, scheduler, paging driver and a storage driver, the interrupt handler coupled to the scheduler and responsive to an interrupt received from a subsystem processor, the scheduler arranged to communicate page load instructions to a paging driver that manages a virtual memory map and further communicates with the storage driver, the storage driver communicating with an embedded multi-media card controller with flash memory; using the interrupt handler to identify an interrupt from a subsystem of a portable computing device, the interrupt including information identifying a page fault identified within the subsystem, and to generate a job request to the scheduler; receiving the job request with the scheduler; generating a corresponding page load instruction with the scheduler; communicating the page load instruction to the paging driver; using the paging driver to generate a read request; communicating the read request to the storage driver; using the storage driver to initiate a direct memory access transfer from the flash memory to a random access memory element accessible to the subsystem processor; receiving an indication from the storage driver that the direct memory access transfer is complete; and generating and communicating a return interrupt to the subsystem in response to the indication from the storage driver that the direct memory access transfer is complete.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a schematic diagram illustrating an example embodiment of a portable computing device.

FIG. 2 is schematic diagram illustrating an example embodiment of a system for supporting demand paging in the PCD of FIG. 1.

FIG. 3 is a schematic diagram illustrating an example embodiment of a subsystem execution environment in the system for supporting demand paging of FIG. 2.

FIG. 4 is a schematic diagram illustrating an example embodiment of an application execution environment in the system for supporting demand paging of FIG. 2.

FIG. 5 is a flow diagram illustrating an example embodiment of a method for managing on demand paging in the system of FIG. 2.

FIGS. 6A and 6B is a flow diagram of an alternative embodiment of a method for managing demand paging in the execution environments of FIG. 3 and FIG. 4.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files or data values that need to be accessed.

As used in this description, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers or execution cores. In addition, these components may execute from various computer-readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the term “portable computing device” (“PCD”) is used to describe any device operating on a limited capacity rechargeable power source, such as a battery and/or capacitor. Although PCDs with rechargeable power sources have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop or tablet computer with a wireless connection, among others.

A scalable framework for enabling on demand paging to support the memory requirements of one or more subsystem execution environments within the PCD is illustrated and described. In the example embodiments, deterministic paging support for such subsystem execution environments is enabled by a hypervisor executing in the application core. Alternatively, a hardware-enabled paging engine operating in conjunction with a memory controller and a flash memory unit can provide a uniform solution for on demand paging for one or more subsystem execution environments in a PCD.

For example, a radio-frequency subsystem includes a modem that contains delay tolerant code and read only data that is not required to support a present operational mode. A digital signal processor and other processing subsystems will use respective delay tolerant code and read only data. Such delay tolerant code and read only data need not be loaded into a random access memory supporting the subsystem at the initial boot or power up of the PCD or initialization of the subsystem. Accordingly, the memory capacity demands of such subsystems can be optimized in those PCDs where a hypervisor or hardware-enabled paging engine is added to the PCD.

Although described with particular reference to operation within a PCD, the described systems and methods are applicable to any computing system having a subsystem with a limited internal memory or access to a limited capacity memory element. Stated another way, the computing systems and methods disclosed herein are applicable to desktop computers, server computers or any electronic device with a limited internal memory capacity. The computing systems and methods disclosed herein are particularly useful in systems or devices that deploy an embedded flash memory as a general purpose storage element.

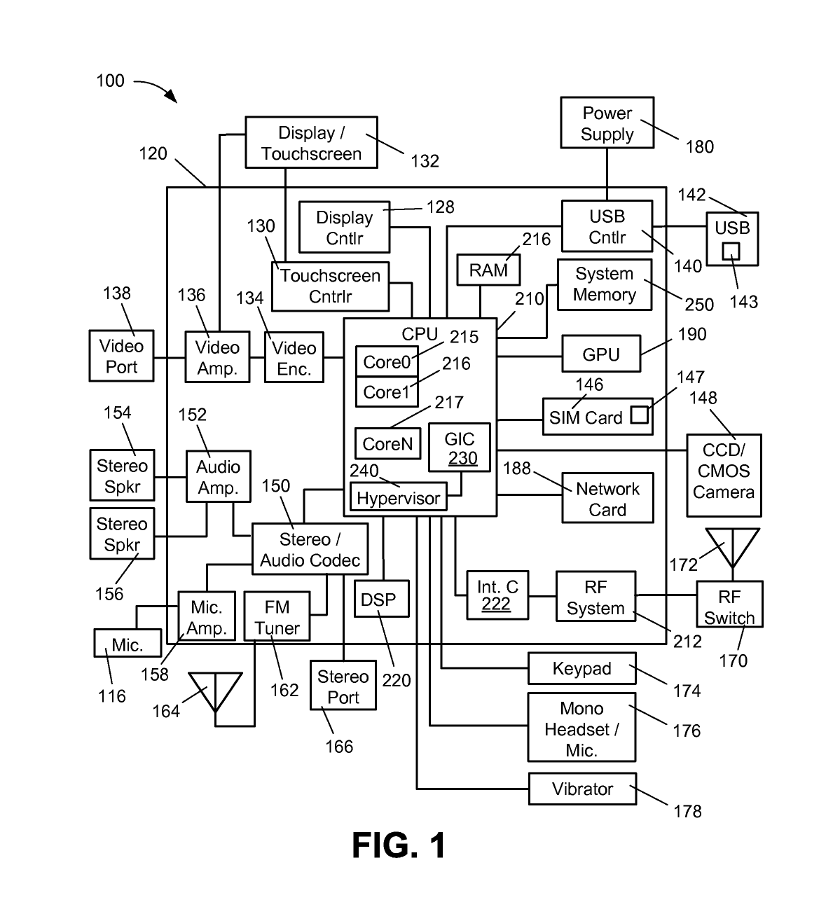

Reference is now directed to the illustrated examples. Referring initially to FIG. 1, an exemplary, non-limiting aspect of a portable computing device (PCD) is shown and is generally designated 100. As shown, the PCD 100 includes an on-chip system 120 that includes a multiple-core CPU 210. The multiple-core CPU 210 includes a zero^{th} core 215, a 1^{st} or first core 216, and an N^{th} core 217, where N is an integer. Each of the N cores are independent from each other and arranged to process instructions such as add, move data, branch, etc. The multiple-core CPU 210 includes at least one general interrupt controller (GIC) 230 and supports the execution of processor instructions that enable a hypervisor 240. Each of the N cores operates in conjunction with signals communicated on the various connections that couple the multiple-core CPU 210 to the other controllers, encoders, decoders supporting the various on-chip and off-chip devices. As briefly described, one or more of these controllers, encoders, decoders, may be operated with limited code and data storage resources.

As illustrated in FIG. 1, a display controller 128 and a touch screen controller 130 are coupled to the multiple-core CPU 210. In turn, display/touchscreen 132, external to the on-chip system 120, is coupled to the display controller 128 and the touch screen controller 130. In addition, a video encoder 134, e.g., a phase alternating line (PAL) encoder, a sequential couleur a memoire (SECAM) encoder, or a national television system(s) committee (NTSC) encoder, are coupled to the multiple-core CPU 210. Further, a video amplifier 136 is coupled to the video encoder 134 and the display/touchscreen 132. A video port 138 is coupled to the video amplifier 136. As depicted in FIG. 1, a universal serial bus (USB) controller 140 is coupled to the multiple-core CPU 210. AUSB storage device 142 is coupled to the USB controller 140. A system memory 230 and a subscriber identity module (SIM) card interface 146 may also be coupled to the multiple-core CPU 210. The connection between the multiple-core CPU 210 and the system memory 230 may consist of two or more physical channels or paths for transferring data between the multiple-core CPU 210 and any of the coupled devices or elements of the on-chip system 120. Further, as shown in FIG. 1, a digital camera 148 may be coupled to the multiple-core CPU 210. In an exemplary aspect, the digital camera 148 is a charge-coupled device (CCD) camera or a complementary metal-oxide semiconductor (CMOS) camera.

As illustrated in FIG. 1, a stereo audio CODEC 150 may be coupled to the multiple-core CPU 210. Moreover, an audio amplifier 152 may be coupled to the stereo audio CODEC 150. In an exemplary aspect, a first stereo speaker 154 and a second stereo speaker 156 are coupled to the audio amplifier 152. FIG. 1 shows that a microphone amplifier 158 may be also coupled to the stereo audio CODEC 150. Additionally, a microphone 116 may be coupled to the microphone amplifier 158. In a particular aspect, a frequency modulation (FM) radio tuner 162 may be coupled to the stereo audio CODEC 150. Also, a FM antenna 164 is coupled to the FM radio tuner 162. Further, a stereo port 166 may be coupled to the stereo audio CODEC 150.

FIG. 1 also indicates that a radio frequency (RF) system or transceiver 212 is coupled to the multiple-core CPU 210 by way of an interrupt controller 220. In the illustrated embodiment, the interrupt controller 220 receives and distributes interrupt signals between the multiple-core CPU 210 and the RF system 212. An RF switch 170 may be coupled to the RF system 212 and an antenna 172. As shown in FIG. 1, a keypad 174 is coupled to the multiple-core CPU 210. Also, a mono headset with a microphone 176 may be coupled to the multiple-core CPU 210. Further, a vibrator device 178 may be coupled to the multiple-core CPU 210. FIG. 1 further shows that a power supply 180 may be coupled to the on-chip system 120 via the USB controller 140. In a particular aspect, the power supply 180 is a direct current (DC) power supply that provides power to the various components of the PCD 100 that require a power source. Further, in a particular aspect, the power supply 180 is a rechargeable DC battery or a DC power supply that is derived from an alternating current (AC) to DC transformer that is connected to an AC power source.

FIG. 1 further indicates that the PCD 100 may also include a network card 188 that may be used to access a data network, e.g., a local area network, a personal area network, or any other network. The network card 188 may be a Bluetooth network card, a WiFi network card, a personal area network (PAN) card, or any other network card well known in the art. Further, the network card 188 may be incorporated in an integrated circuit. That is, the network card 188 may be a full solution in a chip, and may not be a separate network card 188.

As depicted in FIG. 1, the display/touchscreen 132, the video port 138, the USB port 142, the camera 148, the first stereo speaker 154, the second stereo speaker 156, the microphone 116, the FM antenna 164, the stereo port 166, the RF switch 170, the antenna 172, the keypad 174, the mono headset 176, the vibrator 178, and the power supply 180 are external to the on-chip system 120.

The RF system 212, which may include one or more modems, supports one or more of global system for mobile communications (“GSM”), code division multiple access (“CDMA”), wideband code division multiple access (“W-CDMA”), time division synchronous code division multiple access (“TDSCDMA”), long term evolution (“LTE”), and variations of LTE such as, but not limited to, FDB/LTE and PDD/LTE wireless protocols.

In the illustrated embodiment, a single instance of a multi-core CPU 210 is depicted. However, it should be understood that any number of similarly configured multi-core CPUs can be included to support the various peripheral devices and functions associated with the PCD 100. Alternatively, a single processor or multiple processors each having a single arithmetic logic unit or core could be deployed in a PCD 100 or other computing devices to support the various peripheral devices and functions associated with the PCD 100 as may be desired.

The illustrated embodiment shows a system memory 230 that is arranged within a fully integrated on-chip system 120. However, it should be understood that two or more vendor provided memory modules having a corresponding data storage capacity of M bytes may be arranged external to the on-chip system 120. Wherever arranged, the various memory modules supporting the system memory 230 are coupled to the CPU 210 by way of a multiple channel memory bus (not shown) including suitable electrical connections for transferring data and power to the memory modules. In an example embodiment, the system memory 230 is an embedded flash storage element supported by an embedded multimedia card controller.

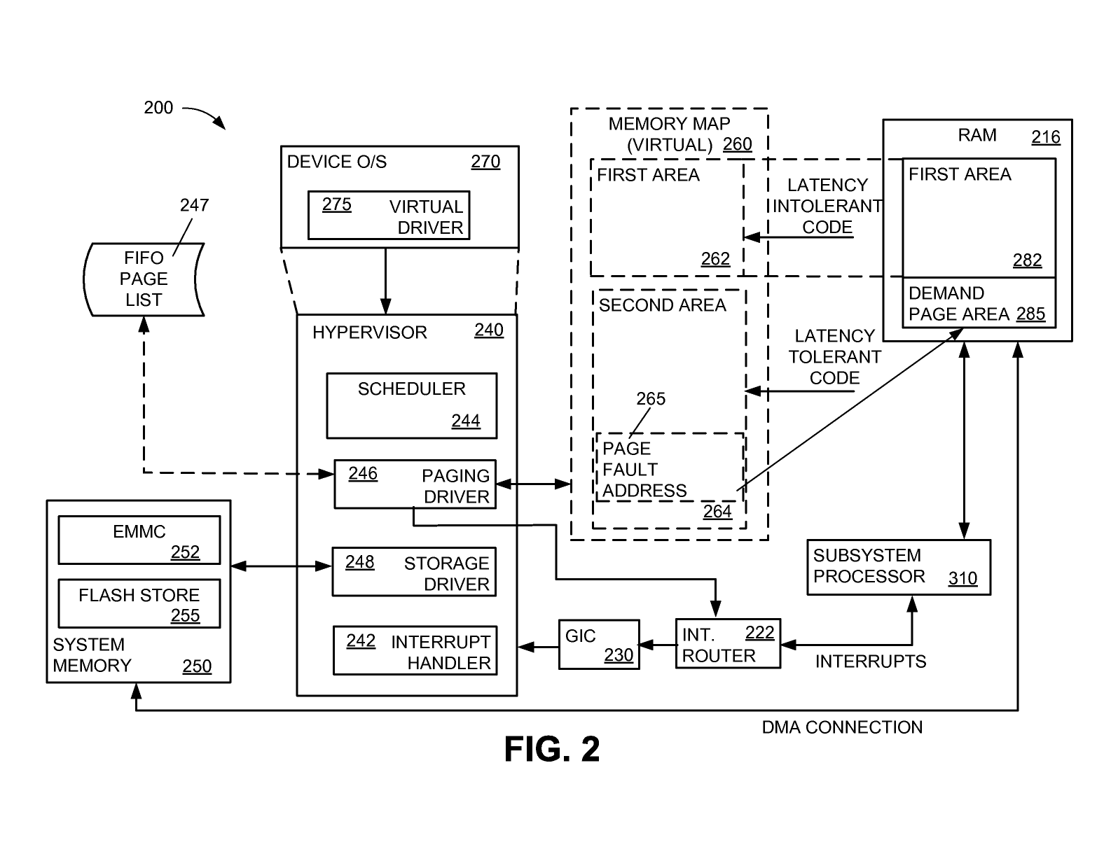

FIG. 2 is schematic diagram illustrating an example embodiment of a system 200 for supporting demand paging in the PCD 100 introduced in FIG. 1. The system 200 includes a primary memory element or RAM 216, a subsystem processor 310, an interrupt router 222, a general interrupt controller (GIC) 230, and a secondary or system memory 250. The subsystem processor 310 is coupled to the RAM 216. The subsystem processor 310 is also coupled via an interrupt signal path with the interrupt router 222. The interrupt router 222 is coupled to the GIC 230 via another interrupt signal path. The interrupt router 222 is disposed or located between the GIC 230 and the subsystem processor 310. The interrupt router 222 generates and distributes interrupt signals between the subsystem processing environment and the application processing environment.

In an embodiment, the GIC 230 is integrated with the multi-core processor 210. Thus, interrupts received by the GIC 230 are available to the interrupt handler 242 of the hypervisor 240. In addition to these elements, the system 200 includes a hypervisor 240 that operates in accordance with execution privileges that exceed those of a device operating system (O/S) 270. The device O/S 270 includes a virtual driver 275 for communicating with the hypervisor 240. Each of the hypervisor 240, the device O/S 270 and the virtual driver 275 are enabled by an application processing environment supported by the multi-core processor 210 and software and data stored in the system memory 250.

As illustrated, the secondary or system memory 250 includes an embedded multi-media card controller (EMMC) 252, which manages a flash based store 255 and supports the non-volatile storage of software and data to support the various subsystems, interfaces and elements on the on-chip system 120.

The hypervisor 240 includes an interrupt handler 242, a scheduler 244, a paging driver 246, and a storage driver 248. The interrupt handler 242 receives interrupt signals from the subsystem processor 310 and other subsystem processors (not shown) via the interrupt router 222 and the GIC 230. The interrupt handler 242, in response to information in a specific interrupt signal, forwards a job request to the scheduler 244. The scheduler 244, acting in conjunction with information provided in the job request, generates a page load command that is forwarded to the paging driver 246. The paging driver 246 interfaces with the storage driver 248 to direct read requests of pages or blocks of stored code and data from the system memory 250. The paging driver 246 also manages the contents of the memory map 260. As part of the management function, the paging driver 246 loads an address of the missing page or block of information in the virtual memory map 260. In addition, the paging driver 246 maintains a first-in first-out list 247 or a database for identifying stale or old page fault addresses that should be removed from the virtual memory map 260. As indicated, the first-in-first-out list 247 may be stored in the system memory 250 or in a set of registers (not shown). In addition to those functions, the paging driver 246 also generates a return interrupt which is communicated to the interrupt router 222 before being forwarded to the subsystem processor 310. The storage driver 248 interfaces with the EMMC 252 to read and write code and data in the flash store 255.

As illustrated, the virtual memory map 260 includes a first area or region 262 and a second area or region 264. The first area 262 includes delay intolerant code, frequently used code and data that supports the operation of one or more subsystems of the PCD 100. The contents of this first area 262 of the memory map 260 is transferred to a corresponding first area 282 of the RAM 216 during a PCD 100 boot operation or when the subsystem is powered on. The memory map 260 also includes a second area or region 264 for maintaining a record of the storage location of latency tolerant code and data that is infrequently used by the one or more subsystems of the PCD 100. Subsystem specific code is stored in the system memory 250 during a configuration or installation procedure. One or more page fault addresses such as the page fault address 265 is recorded in the second area or region 264 of the virtual memory map 260. This information is used to support direct memory access transfers from the system memory 250 to an on-demand page area 285 or region available in the RAM 216. The on-demand page area 285 or region is a range of addressable locations in the RAM 216.

In an alternative embodiment (not shown), the storage driver 248 is replaced by a decompression engine and the system memory 230 includes a random access memory (RAM) module or modules. The latency tolerant code and data stored in the RAM module or modules is compressed either prior to or as a step in the storage process. The decompression engine is responsive to one or more commands or requests issued by the paging driver 246 to access and decompress the compressed latency tolerant code and data stored in the RAM. The decompressed information (code and data) is inserted into the virtual memory map and available for a direct memory access transfer to the primary memory element being used to support the subsystem.

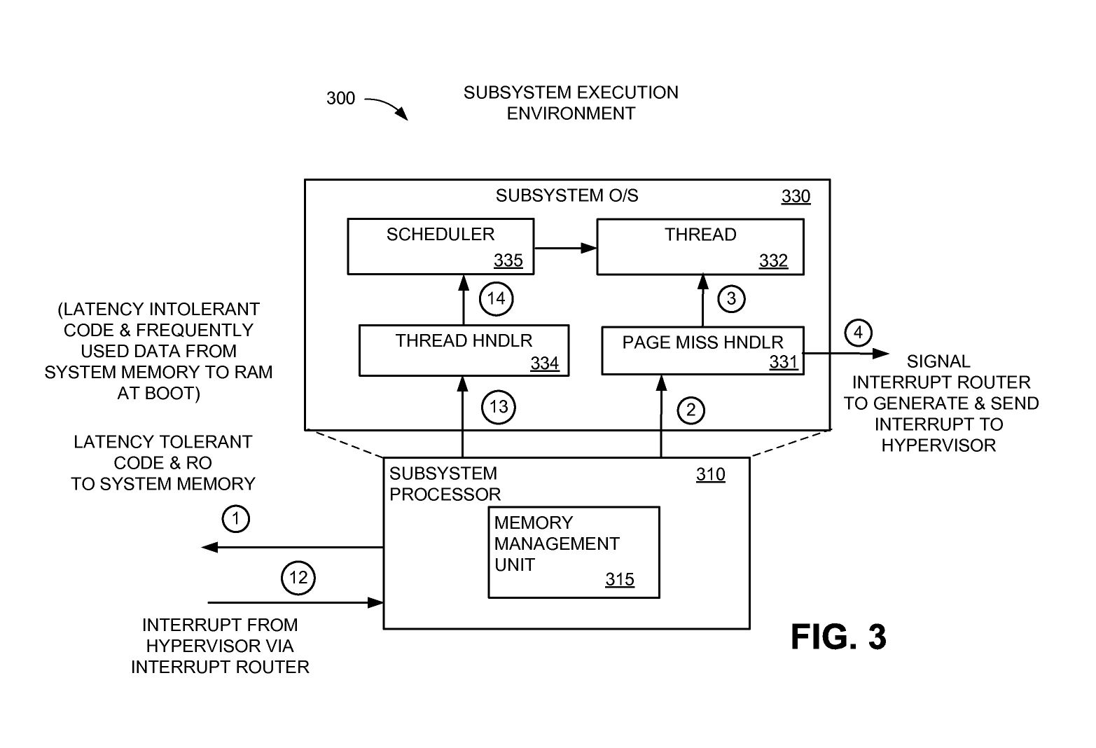

FIG. 3 is a schematic diagram illustrating an example embodiment of a subsystem execution environment 300 in the system for supporting demand paging introduced in FIG. 2. In a preliminary or configuration step or steps, code and data used by the subsystem execution environment 300 is analyzed for frequency of use and its tolerance for delays. As described, delay or latency intolerant code and frequently used read only data may be stored separately from the delay tolerant and infrequently used data. Alternatively, delay intolerant code and frequently used data may be stored together but separately identified from delay tolerant code and infrequently used data. When the PCD 100 is booted, or alternatively when the subsystem is initiated, the delay intolerant code and frequently used data is transferred into a first region or area of the RAM coupled to the subsystem. The delay tolerant and infrequently used data may be stored in the system memory for retrieval as needed by the described system for on demand paging. However defined, code and data used by the subsystem is initially stored in the system memory 230 as indicated by the arrow labeled with an encircled “1.”

As illustrated, the subsystem execution environment 300 is supported by a subsystem processor 310 and a memory management unit 315. Together, the subsystem processor 310 and the memory management unit 315 execute a set of stored instructions arranged to support a thread 332, a page miss handler 331, a thread handler 334, and a scheduler 335. Each of the page miss handler 331, the thread 332, the thread handler 334, and the scheduler 335 are managed under a subsystem operating system 330, which may be a real-time operating system that is not exposed or otherwise accessible to user applications and programs. A thread 332 is a sequence of processor or programmed instructions that can be handled independently. When code or data required by the thread 332 is not present in the RAM 216 (not shown), the subsystem processor 310 acting in conjunction with the memory management unit 315 will forward an indication of a thread local buffer miss to the page miss handler 331, as indicated by the arrow labeled with the encircled “2.” The thread local buffer miss signal is an indication that data required by the executing thread 332 is not presently available in the RAM 216 supporting the subsystem. As further illustrated in FIG. 3, the page miss handler 331 generates a wait or suspend signal to the thread 332 and places a thread identifier in a queue. The communication of the wait or suspend signal from the page miss handler 331 to the thread 332 is illustrated by the arrow labeled with the encircled “3.” As indicated by the arrow labeled with the encircled “4”, the page miss handler 331 also generates and communicates a signal, which is directed to the interrupt router 222 (not shown) and designated for the application execution environment on the PCD. The interrupt router 222 generates an interrupt signal in responsive to information from the page miss handler 331. Accordingly, the interrupt signal communicated from the interrupt router 222 to the hypervisor 240 includes an identifier associated with the thread 332 and an indication of the page or block of information that is required by the subsystem execution environment 300 but presently not available in the RAM 216. While thread 332 is in a wait or suspend state or in the queue, other threads, different from the thread 332 that triggered the local buffer miss signal or fault, may continue to execute in the subsystem execution environment 300 in accordance with rules or algorithms applied by the scheduler 335.

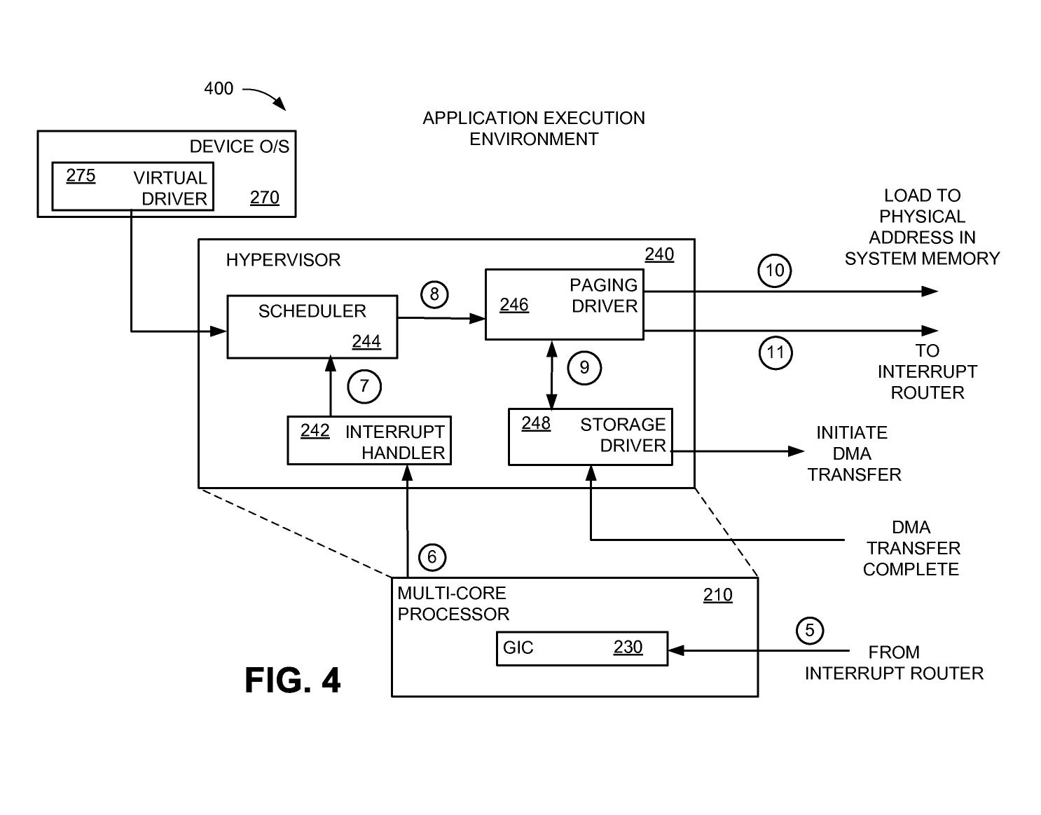

The operation of the hypervisor 240 and the application execution environment is described in detail in association with the embodiment illustrated in FIG. 4. For purposes of understanding the subsystem execution environment 300, as illustrated in FIG. 3, the hypervisor 240 forwards a task complete signal to the interrupt router 222 which in turn generates and forwards an interrupt signal, as indicated by the arrow labeled with the encircled “12” to the subsystem processor 310. The interrupt signal includes information indicating that the missing code and or data identified by the page miss handler 331 of the subsystem is now present and available in the on-demand paging area of the RAM 216. In response to the interrupt from the hypervisor 240, the subsystem processor 310, as illustrated by the arrow labeled with an encircled “13,” sends a page complete signal or command to the thread handler 334 indicating that the paging task is complete. In turn, the thread handler 334 updates a status identifier associated with the thread 332 from “wait” or “suspended” to “ready” and communicates the status change to the scheduler 335, as shown by the arrow labeled “14.”. The scheduler 335, acting in accordance with a scheduling policy, either resumes execution of the suspended thread or leaves the thread 332 in the queue. When appropriate in accordance with the scheduling policy, the scheduler 335 removes the suspended thread from the wait queue and/or reactivates the execution status of the thread 332.

FIG. 4 is a schematic diagram illustrating an example embodiment of an application execution environment 400 in the system for supporting demand paging introduced in FIG. 2. As illustrated, the application execution environment is supported by the multi-core processor 210 executing instructions stored in firmware or software in the PCD. The multi-core processor 210 is arranged to receive interrupt requests in the form of hardware signals from the general interrupt controller 230. Each processing core is coupled via at least one signal path to receive such standard interrupt requests. When the multi-core processor 210 is arranged using an architecture based on a reduced instruction set computing (RISC) architecture, each processing core (not shown) may be further coupled with a second or alternative signal path for receiving a second interrupt signal. These second interrupt signals are associated with a mode of operation that uses a dedicated bank of registers that are not used as part of the standard interrupt processing routine and remain unaltered from one call to the next. When a core receives an interrupt from the second interrupt signal path, it masks the standard interrupt until the second interrupt is processed.

As further illustrated in FIG. 4, the multi-core processor 210 supports a device operating system 270, which includes a virtual driver 275 and generates a hypervisor 240. The hypervisor 240 is a virtual machine monitor for managing a virtual memory map 260 in support of one or more physical memory elements coupled to respective subsystems on the PCD 100 and for managing direct memory access and transfers from a system memory (i.e., a physical memory element with a non-volatile data store) to a random access memory (i.e., a second physical memory element with a volatile data store). A separate and distinct instance of a hypervisor 240 may be initiated and operated to support on demand paging requirements of a separately specified subsystem of the PCD 100. Although the multi-core processor 210 supports the hypervisor 240 (described in the illustrated embodiments as a software entity), the device O/S 270 and user applications on the PCD 100, it should be understood that the hypervisor 240 is granted execution privileges that exceed those of the device O/S 270.

As shown in FIG. 4, the hypervisor 240 is arranged with an interrupt handler 242, a scheduler 244, a paging driver 246, and a storage driver 248. The labeled arrows illustrate a sequence of signals that are communicated to, within and from the application execution environment. The arrow labeled with an encircled “5” represents an interrupt signal received from an interrupt router 222. The received interrupt signal includes information that defines a page or block of information previously stored in the system memory 250 that is not presently available to the subsystem that issued the interrupt. In response to the interrupt signal, the multi-core processor 210 forwards the interrupt signal, as indicated by the arrow labeled with the encircled “6,” to the interrupt handler 242. The interrupt handler 242 receives the interrupt signal and as indicated by the arrow labeled with an encircled “7,” communicates a job request to the scheduler 244. The scheduler 244 operates in accordance with the information received in the job request and in accordance with one or more other signals from the device O/S 270 such as from the virtual driver 275 or hardware sensors distributed across the various systems of the PCD (not shown) to generate and communicate a page load command, which as indicated by the arrow labeled with an encircled “8,” is communicated to the paging driver 246.

The paging driver 246, acting in response to the received page load command, generates a block read command and forwards the command to the storage driver, as illustrated by the arrow labeled with an encircled “9.” The paging driver 246 also manages the contents of the virtual map 260 via one or more signals indicated by the arrow labeled with an encircled “10.” The virtual memory map management process may include limiting the size of the virtual memory by applying or enforcing one or more select criteria to identify candidates for removal from the virtual memory map 260. The select criteria may be supported by a first-in first-out page list 247, a database, or other logic and data including a least recently used algorithm, a random selector, or a capacity comparator included in the paging driver 246. One or more of these select criteria can be implemented once the data represented in the virtual memory map 260 exceeds a threshold value.

Once the paging driver 246 has communicated the block read command and completed any changes to the information in the virtual memory map 260, the hypervisor 240 can be suspended or used to address other tasks until a signal is received from the storage driver 248. The device operating system 270 manages the direct memory access and transfer to the RAM coupled to the operating system that initiated the interrupt signal represented by the arrow encircled with “5.” The virtual driver 275, which may be a para-virtualized driver arranged to communicate with the hypervisor 240, will receive a signal when the direct memory access and transfer operation between the system memory 230 and the RAM 216 is complete. The hypervisor 240 may be suspended or used to address alternative tasks (e.g., manage a schedule, update an address in the memory map, etc.) while the device level operating system 270 manages the data transfer between the system memory 230 and the RAM 216 coupled to the subsystem. Upon receipt of a signal from the storage driver 248 indicating that the direct memory access and transfer is complete, the hypervisor 240 generates and communicates a task complete signal from the paging driver 246 to the interrupt router 222, as indicated by the arrow labeled with an encircled “11.” That is, receipt of the restart signal or indicator from the storage driver 248 signaling that the transfer is complete prompts the hypervisor 240 to generate a task complete signal. The task complete signal is forwarded to the interrupt router 222 and includes information identifying the subsystem and the page or block of information that was transferred to the on demand paging area 285 of the RAM 216. In turn, the interrupt router 222 receives the task complete signal and in response generates and forwards a return interrupt to the subsystem processor 310.

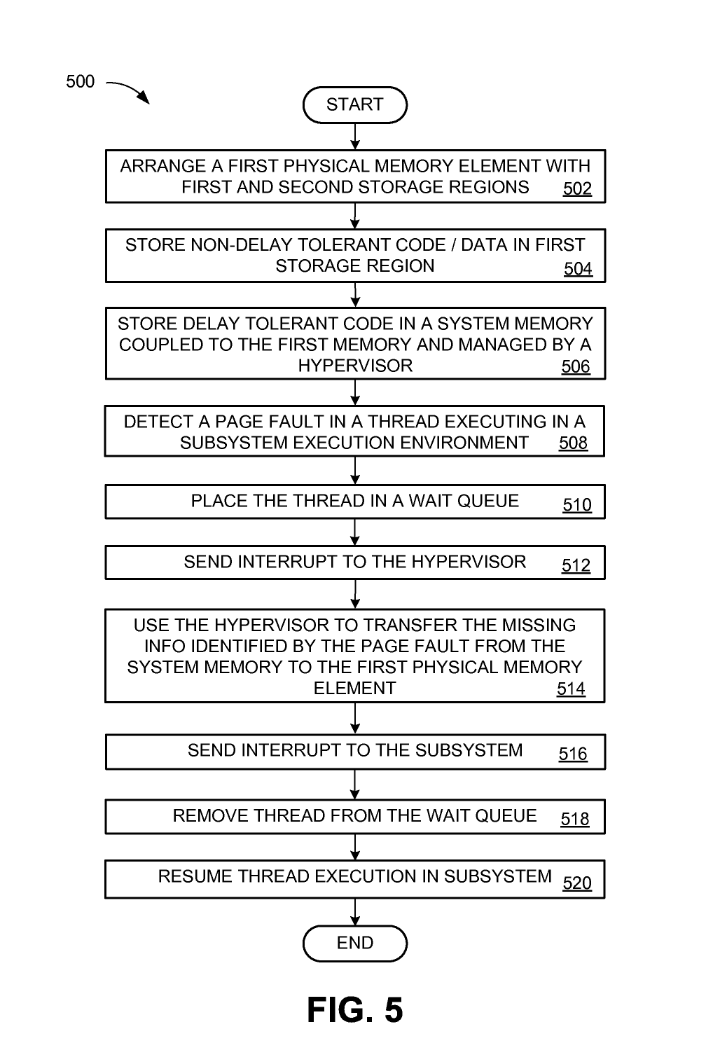

FIG. 5 is a flow diagram illustrating an example embodiment of a method for managing on demand paging in the system of FIG. 2. As described, the method for managing on demand paging is well suited for, but not exclusively applicable to, PCD architectures that include subsystems with dedicated processors and memory management units supported by limited memory resources. Such subsystems may be arranged with a memory element or elements that include insufficient storage capacity to support all operational modes and or demands that are expected to be placed on the respective subsystem.

As illustrated, the method 500 begins with block 502 where a first physical memory element is arranged with first and second storage regions. The first physical memory element may be a dedicated RAM element or a portion of a RAM element coupled to a subsystem. As indicated in block 504, the first storage region or area is used to store delay intolerant or time critical code (also known as latency intolerant code) and read only data that is used by the subsystem. In some arrangements, this first region may also include code or instructions that are frequently used by the subsystem. The first storage region or static area is populated with the time critical code, read-only data, and when applicable, frequently used data. The first storage region or static area is populated when the subsystem is initialized, booted, or started. The second storage region or on-demand area remains unpopulated upon completion of the initialization or startup and is available to receive one or more pages as page faults are detected by the subsystem.

In block 506, a system memory or second physical memory element that is managed by a hypervisor and coupled to the first physical memory element by a data bus is used to store delay tolerant code and data. In an example embodiment, the system memory is an embedded multi-media card controller with a flash memory store. Such a data storage system provides extremely low-latency read data operations and is accessible via conventional direct memory access mechanisms as directed under a device level operating system. As indicated, a device level operating system is an operating system that supports a user application processing environment in the PCD. Such device level operating systems have execution privileges that exceed or supersede execution privileges of a subsystem operating system. Example device level operating systems include iOS, Android, Symbian, webOS and Windows. These example mobile device operating systems allow these devices to execute user applications and programs. In contrast, subsystem operating systems are typically specific to a particular interface of the PCD. These subsystem operating systems will generally support a core function of the PCD. Core functions may include graphics processing, digital signal processing, video encoding/decoding, radio frequency signal processing, etc. For example, a modem (not shown) in a RF system 212 will manage the various functions required to maintain connectivity with a mobile service provider using one or more wireless communication protocols. One or more example subsystems may support real-time functions in the PCD.

In alternative embodiments, (not shown) the contents stored in at least a portion of the system memory or second physical memory are compressed or otherwise encoded to consume less data storage capacity when compared to a format that is readily accessible and usable to the corresponding subsystem. In these alternative embodiments, the system memory may be coupled to a paging driver through a decompression engine that is arranged to decode or decompress the compressed code and data stored therein.

Through known methods and as indicated in block 508, the subsystem will detect or otherwise identify that an executing thread is in need of code, data or both code and data that is not presently available in the first physical memory element. This condition is commonly known as a page fault or a miss. As indicated in block 510, the subsystem suspends the presently executing thread and places the executing thread in a wait queue. In block 512, the subsystem initiates and sends an interrupt to the hypervisor. The interrupt identifies a page or block of information in the system memory that is needed by the subsystem to complete the suspended thread.

Thereafter, as indicated in block 514, the hypervisor is used to transfer the missing information identified in the received interrupt from the system memory to the first physical memory element. The hypervisor is arranged with an interrupt handler that forwards a job or task request to a scheduler. The scheduler may be arranged as a single execution thread that generates a page load request to the paging driver in accordance with various signals received from the device level operating system. As briefly described, the paging driver of the hypervisor preferably sends a block read command to the storage driver and relinquishes control to the device level operating system. The block read command includes all the information that the storage controller requires to access, read and forward the identified page or block of data to the first physical memory element. Accordingly, once the block read command is communicated to the storage controller, the hypervisor can be suspended or is available to perform other tasks until the storage driver receives an indication or signal from the device level operating system that the direct memory access operation has successfully transferred the block or page to the first physical memory element. As indicated in block 516, upon receipt of an indicator or signal that the DMA transfer is complete, the hypervisor sends an interrupt to the subsystem that requested the block or page of information. As described, the device level operating system will include a para-virtualized driver that communicates with the hypervisor rather than directly with the subsystem.

The subsystem, acting in response to the interrupt from the hypervisor, removes the suspended thread from the wait queue, as indicated in block 518. Thereafter, as illustrated in block 520, the subsystem updates status information associated with the suspended thread. As described, the subsystem may resume execution of the thread in accordance with a thread handler acting in accordance with a subsystem scheduling policy.

As briefly described, a paging driver associated with the hypervisor may be arranged to implement a page replacement policy when maintaining a virtual memory map. Such a page replacement policy may implement one or more selection criteria including one or more of a first-in first-out, least recently used, capacity and even a random replacement policy, among others. These selection criteria for moving information into and out from the virtual map may be preprogrammed, set by a configuration file, or managed by one or more applications on the PCD. A first-in first-out policy removes the oldest page or block of information from first-in first-out page list 247 that corresponds to the information stored in the second area 264 of the virtual map 260. Such a page replacement policy may also be used to identify information to be replaced, overwritten or simply removed from an on-demand paging area 285 of the RAM 216.

A least recently used policy will maintain a record of the last use of those pages or blocks of code and data in the second area 264 of the virtual map 260. A most recently used page or block of code is indicated by the block or page last requested to be transferred from a physical or system storage element to the virtual map 260. In contrast, a least recently used page or block is marked for replacement or to be overwritten by the next requested block or page. A selection criteria based on the capacity of the next requested block or page of data will look for a correspondingly sized block or page and replace the same with the information associated with the next requested block or page of data. A random selection criteria may select a page or block of data for replacement and/or removal from the second area 264 of the virtual memory map 260 using a random or indiscriminate number generator and associating the random number with one of the blocks or pages in the virtual memory such that the associated blocks or pages are marked for replacement by the next selected page or block.

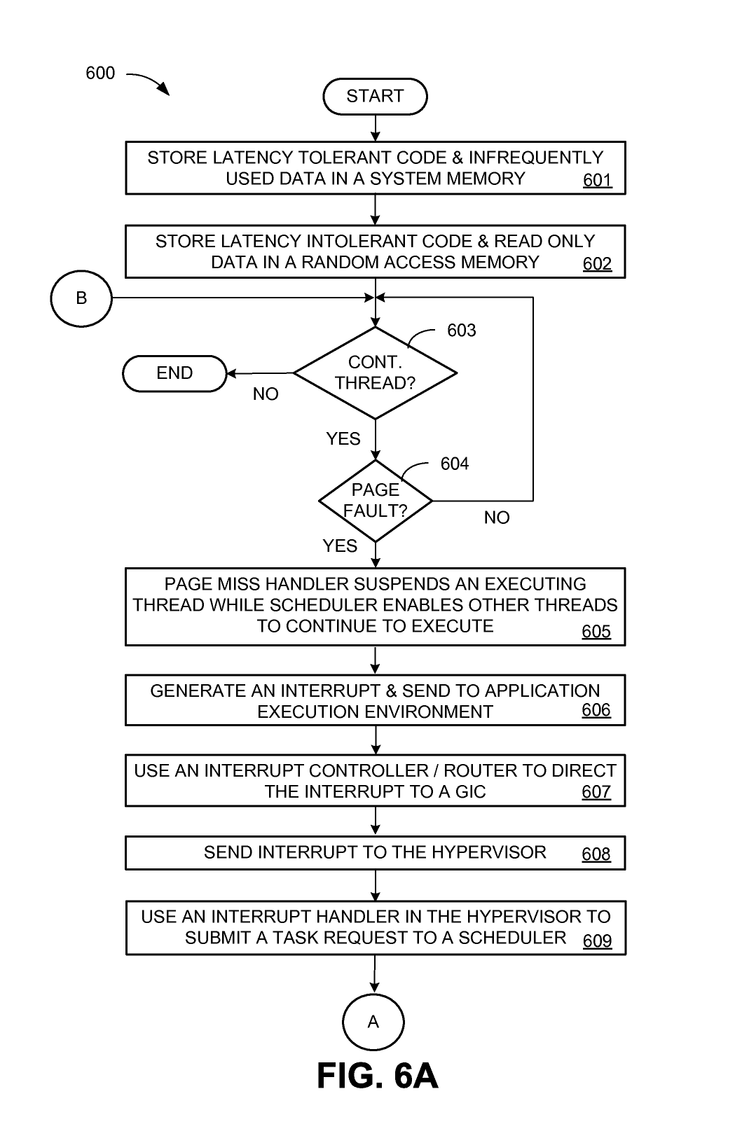

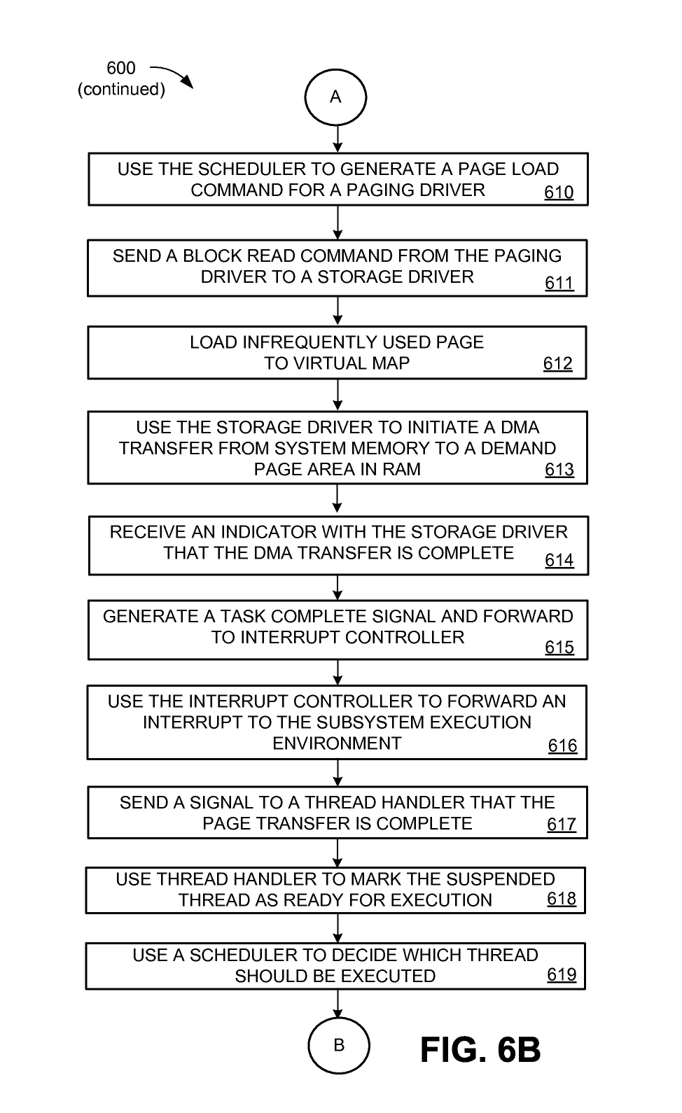

FIGS. 6A and 6B is a flow diagram of an alternative embodiment of a method 600 for managing demand paging in the execution environments of FIG. 3 and FIG. 4. The method 600 begins with block 601 where latency tolerant code and infrequently used data is stored in a system or shared memory element in the PCD. In block 602, latency intolerant code and read only data required by a defined subsystem are transferred from a non-volatile memory, such as the system memory to a first region or area of a random access memory coupled to the subsystem. The code and data transfer of block 602 may occur during a device boot process or during a subsystem initialization step.

In decision block 603 it is determined whether additional instructions remain in the executing thread. When additional instructions remain processing continues with the decision block 604. Otherwise, the thread is terminated and the method 600 ends.

In decision block 604, a page fault is identified by the processor supporting the subsystem execution environment. When no page fault is present, the subsystem has access to all the code and read only data that it requires to process one or more threads. As indicated by the flow control arrow labeled “No” exiting the decision block 604, processing of the one or more threads in the subsystem continues until a page fault is indicated or all the instructions in the thread have been executed.

Otherwise, when a page fault is indicated, as shown by the flow control arrow labeled “Yes” exiting decision block 604, the method 600 continues with block 605 where the subsystem suspends a thread requiring code or data not presently available in the RAM coupled to the subsystem. As described, the subsystem places the thread in a queue while the subsystem waits for an indication that the required code or data has been transferred into the RAM. As further illustrated in block 605, while the thread associated with the page fault or page miss is suspended or in the queue, subsystem resources are available to continue the execution of other threads with sufficient memory resources located in the RAM. As briefly described above, a scheduler implementing a policy may be provided to manage the execution status of these other threads. In block 606, the subsystem generates an interrupt directed to the application execution environment of the PCD. The interrupt identifies the code and or data stored in the system memory and not available in the RAM.

In block 607, an interrupt controller or router is used to direct the interrupt from the issuing subsystem to the general interrupt controller in the application execution environment. In block 608, the general interrupt controller forwards the interrupt to the hypervisor. Next, in block 609, an interrupt handler in or associated with the hypervisor receives the interrupt and in accordance with the information sent by the subsystem generates a corresponding task request to a scheduler. As indicated by connector A, the method 600 continues with block 610, where the scheduler, acting in response to the task request and one or more inputs from the operating system, generates and communicates a page load command to a paging driver.

The paging driver, acting in response to the page load command, generates a block read command and forwards the command to the storage driver, as illustrated in block 611. In block 612, the paging driver also updates the information in the virtual map. The update process includes loading a page or block address into the virtual map. The update process may include managing the size of the virtual memory by applying a first-in first-out criteria when the usage of the virtual memory exceeds a threshold. In block 613, the storage driver initiates a direct memory access and transfer of the requested information or page from the system memory to a demand paging area of the RAM coupled to the subsystem. As described, the hypervisor is available to perform other tasks while the device level operating system manages the data transfer between the system memory and the RAM coupled to the subsystem.

As indicated in block 614, the storage driver of the hypervisor receives an indication or signal from the operating system that the direct memory access and transfer operation is complete. As shown in block 615, the paging driver of the hypervisor generates a task complete signal and forwards the same to the interrupt controller. In turn, as illustrated in block 616, the interrupt controller forwards a corresponding interrupt signal to the subsystem execution environment.

Thereafter, as shown in block 617, the subsystem processor communicates the received interrupt to a thread handler. In turn, the thread handler marks the identified thread as ready for execution, as indicated in block 618. As described, the thread handler may send a resume thread signal (e.g., the thread handler may communicate a change to a status identifier). As indicated in block 619, a scheduler, supported by the subsystem processor 310, determines an appropriate time to resume execution of the thread responsible for the page fault. As indicated by connector B, the method 600 continues by repeating the functions associated with decision block 603, decision block 604 and block 605 through block 619 as desired.

Certain steps in the processes or process flows described in this specification naturally precede others for the invention to function as described. For example, subsystem instructions and read only data should be analyzed in order to determine whether such information is latency tolerant or intolerant. Once such a determination has been made, latency intolerant code and data, and in some cases frequently used code, is optimized stored for transfer upon subsystem initialization to a random access memory or other physical memory element provided to support a respective subsystem. Conversely, latency tolerant code and infrequently used data may be optimized and in some cases compressed or encoded before being stored in a system memory. However, the present system and methods are not limited to the order of the steps described if such order or sequence does not alter the functionality of the above-described systems and methods. That is, it is recognized that some steps may be performed before, after, or in parallel (substantially simultaneously) with other steps. In some instances, certain steps may be omitted or not performed without departing from the above-described systems and methods. Further, words such as “thereafter”, “then”, “next”, “subsequently”, etc. are not intended to necessarily limit the order of the steps. These words are simply used to guide the reader through the description of the exemplary method.

Additionally, one of ordinary skill in programming is able to write computer code or identify appropriate hardware and/or circuits to implement the disclosed systems and methods without difficulty based on the flow charts and associated examples in this specification. Therefore, disclosure of a particular set of program code instructions or detailed hardware devices is not considered necessary for an adequate understanding of how to make and use the systems and methods. The inventive functionality of the claimed processor-enabled processes is explained in more detail in the above description and in conjunction with the drawings, which may illustrate various process flows.

In one or more exemplary aspects as indicated above, the functions described may be implemented in hardware, software, firmware, or any combination thereof. If implemented in software, the functions may be stored as one or more instructions or code on a computer-readable medium, such as a non-transitory processor-readable medium. Computer-readable media include data storage media.

A storage media may be any available media that may be accessed by a computer or a processor. By way of example, and not limitation, such computer-readable media may comprise RAM, ROM, EEPROM, Flash, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of non-transitory computer-readable media.

Although selected aspects have been illustrated and described in detail, it will be understood that various substitutions and alterations may be made herein without departing from the present systems and methods, as defined by the following claims.

What is claimed is:

1. A portable computing device, comprising:
a processor supported by an memory management unit, the processor and the memory management unit arranged to execute threads under a subsystem level operating system, the subsystem level operating system arranged to identify a page fault and generate an interrupt;
a primary memory coupled to the processor, the primary memory having a first area for time critical code and read only data and a second area for pages required by a thread executing on the processor;
a secondary memory accessible to a hypervisor, the hypervisor in response to the interrupt, generates instructions that initiate a direct memory transfer of information in the secondary memory to the second area of the primary memory, and upon completion of the direct memory transfer forwards a task complete acknowledgement to the processor.

2. The portable computing device of claim 1, wherein the hypervisor uses a paging driver and a storage driver specific to the secondary memory to locate information responsive to the interrupt.

3. The portable computing device of claim 2, wherein the hypervisor uses the paging driver to load the information into the primary memory and to forward the task complete acknowledgement.

4. The portable computing device of claim 1, wherein the hypervisor generates a first-in first-out list for managing one or more pages of information in the second area of the primary memory.

5. The portable computing device of claim 1, further comprising:
a general interrupt controller operating under a device level operating system and coupled to the hypervisor; and
an interrupt router disposed between the general interrupt controller and the processor.

6. The portable computing device of claim 1, wherein the processor, upon detecting the page fault, suspends execution of a thread responsible for the page fault and upon receipt of the task complete acknowledgement, forwards a page complete signal to a queue.

7. The portable computing device of claim 6, wherein the processor resumes execution of the thread responsible for the page fault.

8. A method for on-demand paging across subsystems in a portable computing environment with limited memory resources, the method for on-demand paging comprising:
arranging a first physical memory element with a first storage region and a second storage region;
storing delay intolerant code in the first storage region of the first physical memory element;
transferring information from the first storage region to a corresponding area of a second physical memory element;
storing delay tolerant code in the second storage region of the first physical memory element;
detecting a page fault related to a task executing in a subsystem;
placing the task in a wait queue;
communicating an interrupt to a hypervisor;
using the hypervisor to manage a transfer of information identified by the page fault as missing from the second physical memory element from the second storage region of the first physical memory element to a demand paging area in the second physical memory element;
communicating an interrupt to the subsystem; and
changing an indicator associated with the task.

9. The method of claim 8, wherein the hypervisor initiates a direct memory access transfer.

10. The method of claim 9, wherein upon completion of the direct memory access transfer, the hypervisor receives an indication that the transfer is complete.

11. The method of claim 10, wherein receipt of the indication that the transfer is complete prompts the hypervisor to generate the interrupt to the subsystem.

12. The method of claim 8, wherein the hypervisor uses a paging driver to manage a virtual memory map.

13. The method of claim 12, wherein the paging driver enforces a page replacement policy.

14. The method of claim 13, wherein the page replacement policy includes a selection criteria from a group consisting of first-in first-out, least recently used, capacity and random.

15. The method of claim 12, wherein the hypervisor uses a storage driver to access the first physical memory element through a storage controller.

16. The method of claim 15, wherein the storage controller is an embedded multi-media card controller with a flash memory.

17. The method of claim 12, wherein the hypervisor uses a scheduler to communicate a page load request to the paging driver.

18. A non-transitory processor-readable medium having stored thereon processor instructions that when executed direct the processor to perform functions, comprising:
generating a hypervisor having an interrupt handler, a scheduler, a paging driver and a storage driver, the interrupt handler coupled to the scheduler, the scheduler arranged to communicate page load instructions to the paging driver, the paging driver manages a virtual memory map and further communicates with the storage driver, the storage driver communicating with an embedded multi-media card controller with flash memory;
using the interrupt handler to identify an interrupt from a subsystem of a portable computing device, the interrupt including information identifying a page fault identified within the subsystem, and to generate a job request to the scheduler;
receiving the job request with the scheduler;
generating a corresponding page load instruction with the scheduler;
communicating the corresponding page load instruction to the paging driver;
using the paging driver to generate a read request;
communicating the read request to the storage driver;
using the storage driver to initiate a direct memory access transfer from the flash memory to a random access memory element accessible to the subsystem;
receiving, with the storage driver, an indication that the direct memory access transfer is complete; and
generating and communicating a return interrupt to the subsystem in response to the indication that the direct memory access transfer is complete.

19. The non-transitory processor-readable medium of claim 18, wherein the paging driver enforces a page replacement policy to update pages stored in a physical memory coupled to the subsystem.

20. The non-transitory processor-readable medium of claim 19, wherein the page replacement policy includes a selection criteria to identify information to be removed from anon-demand paging region of the physical memory.
